(19) United States
(12) Patent Application Publication
(10) Pub. No.: US 2009/0042582 A1
(43) Pub. Date: Feb. 12, 2009

(54) METHOD AND APPARATUS FOR LTE RACH CHANNEL RESOURCE SELECTION AND PARTITIONING

(75) Inventors: Jin Wang, Central Islip, NY (US); Peter S. Wang, East Setauket, NY (US); Shankar Somasundaram, Deer Park, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS INC., Wilmington, DE (US)

(21) Appl. No.: 12/188,738

(22) Filed: Aug. 8, 2008

Related U.S. Application Data
(60) Provisional application No. 60/955,239, filed on Aug. 10, 2007.

(51) Int. Cl. H04Q 7/20

(52) U.S. Cl. 455/450

(57) ABSTRACT

A method and apparatus for random access channel (RACH) channel selection in a long term evolution (LTE) network includes determining a distance from a wireless transmit/receive unit (WTRU) to an evolved Node-B (eNB) in a cell of the LTE network. A RACH channel is then selected based upon the distance determination.

### CROSS REFERENCE TO RELATED APPLICATIONS

This application claims the benefit of U.S. Provisional Application No. 60/955,239, filed Aug. 10, 2007, which is incorporated by reference as if fully set forth.

### FIELD OF INVENTION

This application is related to wireless communications.

### BACKGROUND

Current efforts for the Third Generation Partnership Project (3GPP) Long Term Evolution (LTE) program is to develop new technology and new architectures for new methods and configurations in order to provide improved spectral efficiency, reduced latency and better utilization of radio resources for faster user experiences and richer applications and services with less cost.

One of the resources that is utilized in an LTE network is the random access channel (RACH). The RACH, in turn, is mapped to the physical RACH (PRACH), which includes preamble resources. Accordingly, the RACH and PRACH resource may be considered as being the same resource. This resource may include items such as:
The number of RACH channels in the frequency domain.
The preamble group reserved for different access conditions and purposes.
The preambles that are in the time domain for which a wireless transmit/receive unit (WTRU) may transmit a random access preamble to an evolved universal terrestrial radio access network (E-UTRAN).
The preamble sequences, (e.g., signatures) in the code domain for which some initial access information bits may be encoded together. For each RACH channel, there may be sixty-four (64) available preamble sequences.

Currently, the preambles of a RACH are partitioned into dedicated and non-dedicated preambles. Of the dedicated preambles, one is selected and assigned by the E-UTRAN to the WTRU for its RACH access. For example, a dedicated preamble may be assigned for handover. Of the non-dedicated preambles, one is selected by the WTRU at the time of RACH access. The selected non-dedicated preamble may occur over one of the two preamble groups over a RACH channel.

It would therefore be beneficial to provide a method and apparatus for LTE RACH channel resource selection and partitioning.

### SUMMARY

A method and apparatus for random access channel (RACH) channel selection, random access preamble group partition and selection and a non-dedicated preamble selection in a long term evolution (LTE) network is disclosed. The method includes determining a distance from a transmitter in a cell of the LTE network. A RACH channel is then selected based upon the distance determination.

### BRIEF DESCRIPTION OF THE DRAWINGS

A more detailed understanding may be had from the following description, given by way of example in conjunction with the accompanying drawings wherein:

FIG. 1 shows an example wireless communication system including a WTRU and an evolved Node-B (eNB);

FIG. 2 is an example functional block diagram of a WTRU and eNB of FIG. 1; and

FIG. 3 is a flow diagram of a method of RACH channel selection based on distance or signal pathloss from the eNB;

FIG. 4 is an example diagram of time aligned RACH bursts on different channels;

FIG. 5 is an example diagram of time-wise spread random access (RA) bursts; and

FIG. 6 is flow diagram of a method of determining a failure cause.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

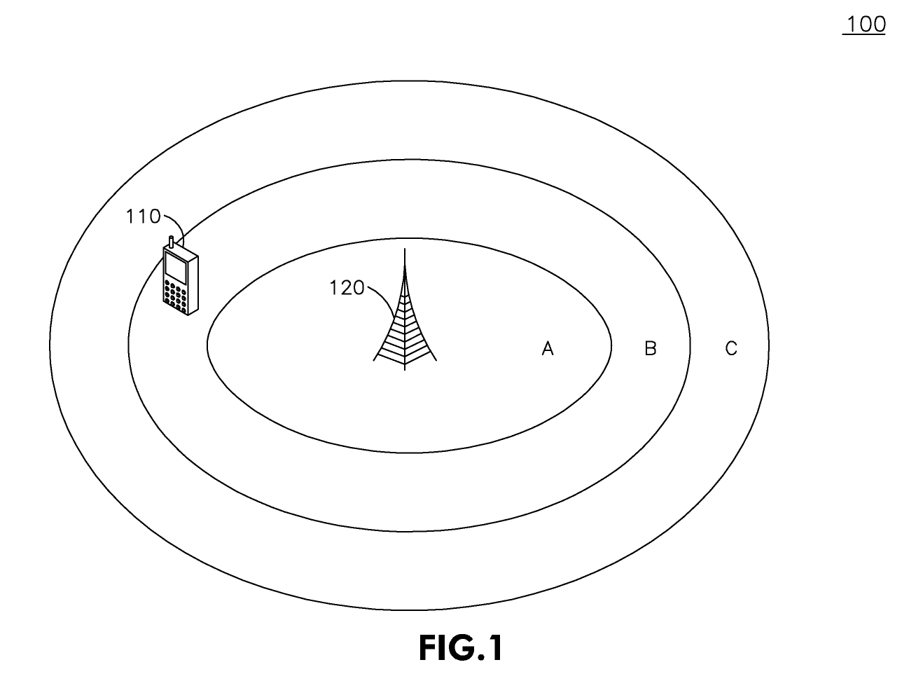

FIG. 1 shows an example wireless communication system 100 including a WTRU 110 and an eNB 120. As shown in FIG. 1, the WTRU 110 is in communication with the eNB 120. It should be noted that, although an example configuration of a WTRU 110 and an eNB 120 is depicted in FIG. 1, any combination of wireless and wired devices may be included in the wireless communication system 100.

Surrounding the eNB 120 is regions of areas enclosed by concentric circles and designated “A”, “B”, and “C”. That is, the innermost concentric circle to the eNB 120 serves to indicate the radio signal strength threshold of area A with a threshold value, the middle concentric circle serves to indicate the radio signal strength threshold of area B with its threshold value, and the outermost concentric circle from the eNB 120 serves to indicate the radio signal strength threshold of area C and threshold value. It should be noted that although concentric circles are shown delineating areas A, B, and C, the areas A, B, and C could be enclosed by any type of shape.

For purposes of example, area A is shown as a region that is situated relatively close in proximity to the eNB 120 and therefore may include a characteristic associated with it, (e.g. the least radio signal pathloss). Likewise, areas B and C are shown as regions that are respectively progressively farther from the eNB 120 than area A. Accordingly, the areas B and C may include characteristics associated with their locations as well, such as larger pathlosses than area A.

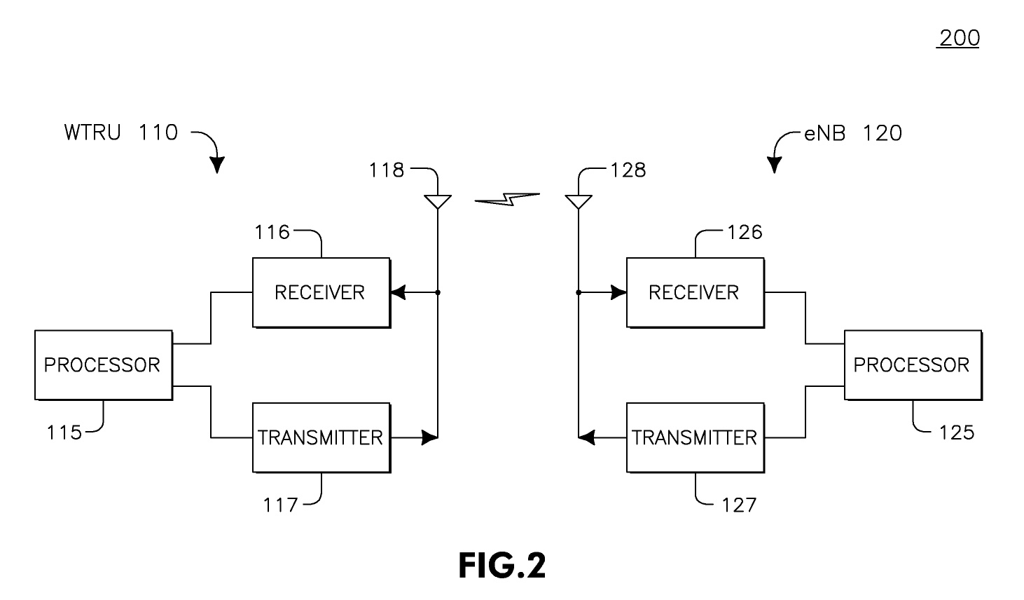

FIG. 2 is an example functional block diagram 200 of a WTRU 110 and the eNB 120 of the wireless communication system 100 of FIG. 1. As shown in FIG. 2, the WTRU 110 is in communication with the eNB 120.

In addition to the components that may be found in a typical WTRU, the WTRU 110 includes a processor 115, a receiver 116, a transmitter 117, and an antenna 118. The receiver 116 and the transmitter 117 are in communication with the processor 115. The antenna 118 is in communication with both the receiver 116 and the transmitter 117 to facilitate the transmission and reception of wireless data. The processor 115 of the WTRU 110 is configured to perform RACH channel selection, preamble group partitioning and selection, and individual RACH preamble selection.

In addition to the components that may be found in a typical eNB, the eNB 120 includes a processor 125, a receiver 126, a transmitter 127, and an antenna 128. The receiver 126 and the transmitter 127 are in communication with the processor 125. The antenna 128 is in communication with both the receiver 126 and the transmitter 127 to facilitate the transmission and reception of wireless data. The processor 125 of the eNB 120 is configured to perform RACH channel selection and partitioning.

For a large bandwidth LTE cell, such as a 15 MHz or 20 MHz cell, an E-UTRAN may allocate one or more RACH channels for random access to support simultaneous access for a large number of WTRUs 110. For example, there may be k RACH channels, where k is greater than one, (k>1), either configured by the E-UTRAN and communicated via a system information broadcast or defined by a standard specification according to the cell capacity, (i.e., the cell transmit bandwidth), and derived by the WTRU once the WTRU has acquired the cell transmit bandwidth, for example. The RACH channels may be indexed in order of appearance in the system information, (i.e., 0, 1, . . . , k−1) or by their frequency resource locations in the uplink spectrum, (e.g., from higher frequency to lower frequency as 0, 1, . . . k−1, or from lower frequencies to higher or alternating starting from the center frequency and up and down). Accordingly, a WTRU 110 may select one of the allocated RACH channels for use.

One way in which the WTRU 110 may select a RACH channel depends on the state that the WTRU 110 is in and the availability of WTRU identities, such as the international mobile subscriber identity (IMSI), temporary mobile subscriber identity (TMSI), cell radio network temporary identifier (C-RNTI), or S-TMSI. Other identities for the WTRU 110 may also be utilized. In this example, the WTRU 110 selects the RACH using the index RA-CHAN, in accordance with the following equation:

RA-CHAN=(C-RNTI, TMSI or IMSI, in order of availability) mod k. Equation (1)

For example, in accordance with Equation (1), when the WTRU 110 powers on, the only UE-Id available may be the IMSI embedded in a subscriber identity module (SIM) card in the WTRU 110. As an example, if the WTRU 110 has an IMSI number 237, and in the cell there are 6 RACHs, then the RACH channel index is obtained by 237 mod 6=3. Thus, the WTRU 110 selects the fourth RACH channel to send its initial access request since the modulo operation result is “zero” based, (i.e., 0 for the first RACH. Accordingly, a rule may be set for each WTRU 110 with different ID values in the cell picking up a different RACH to minimize random access collision probability.

Alternatively, the WTRU 110 could select the RACH channel in accordance with the following equation:

RA-CHAN=RAND_{UE-Id} mod k, Equation (2)

where RAND_{UE-Id} is a random number generated by the WTRU using its own appropriate UE-Id, available at the time (e.g., C-RNTI (after RRC connection is established), IMSI (when the WTRU 110 is in Idle and no TMSI is assigned), or TMSI (when a TMSI is assigned and no valid C-RNTI is available)). The E-UTRAN may require the WTRU 110 to select the RACH channel in accordance with Equation (2) if, for example, the E-UTRAN determines after a period of time that RACH channel selection in accordance with Equation (1) is not providing an even enough distribution of chosen RACH channels, resulting in many random access collisions.

It may also be the case where an LTE cell covers such a large geographical area, (e.g., ≧100 km), that the cell may need to partition the coverage range. Referring back to FIG. 1, the LTE cell may utilize one or more RACHs to support each area A, B, and C, with a different RACH preamble group, preamble format, or a preamble from a group. For example, a first preamble, which may be a normal type of cyclic prefix with a preamble format, may be utilized for short distances from the eNB 120, such as in area A. A second preamble with an extended type of cyclic prefix and preamble format, may be utilized for mid range areas such as area B. or a long range for area C. In this manner, an increase in the cell's random access service quality and efficient RACH resource utilization, based on the A, B or C area characteristics, may be achieved.

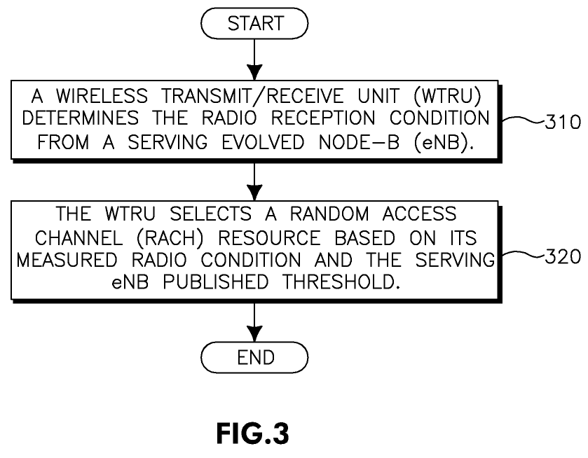

FIG. 3 is a flow diagram of a method 300 of RACH resource preamble selection based on the distance or the radio reception condition from the eNB 120. The measurement quantity utilized is the pathloss. In step 310, the WTRU 110 determines its distance or the signal pathloss from the eNB 120. One way in which the WTRU 110 may determine its distance is by measuring the pathloss, (e.g., via reference signal received power (RSRP)), of the power on the relevant downlink (DL) channel over the reference symbols. The pathloss signal may be roughly equated to the transmission range or compared against a threshold published by the serving eNB 120 for selecting a RACH with a RACH resource such as the preamble cyclic type, a preamble format, a preamble or all of these resources.

As an alternative to measuring the pathloss of the power on the relevant DL channel, the transmit power of a typical DL channel, (e.g., Tx-power), may be signaled to the WTRU 110 by the E-UTRAN, for example via a system information broadcast. In addition, the E-UTRAN may broadcast/publish the pathloss-equivalent range threshold values for the WTRU 110 to use in determining its RACH access transmitting range.

If the WTRU 110 estimates the pathloss, it may estimate it in accordance with the following equation:

UE-estimate-pathloss=Tx-power−RSRP, Equation (3)

where the RSRP is the averaged RSRP value for overcoming any sudden deep fading due to the signal propagation environment.

The WTRU 110 may then select a RACH channel based upon the determination of the distance from the eNB 120 (step 320). For example, the WTRU 110 may select an appropriate RACH channel or a RACH preamble according to provided threshold values. That is, the greater the pathloss, the farther away from the eNB 120 the WTRU 110 is or the worse the radio propagation condition is. Therefore, the WTRU 110 may select a longer length preamble for the RACH access or may select a heavier forward error correction (FEC) coding or a data block size format to transmit data more reliably. For example, referring back to FIG. 1, the threshold, as compared against the pathloss measured by the WTRU 110 for area C, (i.e., Threshold_{FAR-range}), should be greater than the threshold for area B, (i.e., Threshold_{MID-range}) for quantifying the radio signal loss.

Accordingly, if the pathloss estimate is greater than or equal to the threshold for area C, (i.e., UE-estimate-pathloss≧Threshold_{FAR-range}), then the WTRU 110 selects a RACH with a preamble extended cyclic prefix type as described above. If the pathloss estimate is less than the threshold for area C, but greater than the threshold for area B, (i.e., Threshold_{FAR-range}>UE-estimate-pathloss≧Threshold_{MID-range}), then the WTRU 110 selects a RACH preamble having either an extended type of cycle prefix as described above or a normal type. In the example shown in FIG. 1, the WTRU 110 is in this scenario, (i.e., the WTRU 110 is in area B). If the pathloss is less than the threshold for area B, then the WTRU 110 selects a RACH preamble having a normal cyclic type. The E-UTRAN may provide the thresholds when configuring the random access preambles with the extended or normal cyclic prefix types, thresholds for preamble formats, or preamble groups.

An additional factor that may impact the measurement is the amount of interference, (e.g., uplink (UL) interference), the eNB 120 may be experiencing. Accordingly, the WTRU 110 may account for that factor by applying the following equation:

UE-estimated-transmission-factor=Tx-power−RSRP+UL interference, Equation (4)

where the UL interference may be signaled from the serving eNB 120 via a system information broadcast. The WTRU 110 may then apply the UE-estimated-transmission-factor for the determinations of selecting random access preamble cyclic prefix types, a preamble group, or a preamble format as described above with one or more threshold values sent by the serving cell.

It is also conceivable that the WTRU 110 may determine to use a higher end cyclic prefix type, (e.g., the extended), a preamble group for a longer range, a preamble format for the longer range, a higher order of FEC, or a smaller data block format for the RACH resource. This may be to achieve better random access quality within configured RACH resources and/or if an incompatible signaling situation occurs, such as having a missing threshold. Referring again to the example of FIG. 1, where the WTRU 110 is shown in area B within the midrange threshold, if the midrange threshold does not exist or is not provided, the WTRU 110 may select to utilize a repeated type RACH such as may be utilized in area C.

For an LTE WTRU 110 that is equipped with a global positioning device (GPS), its distance to the eNB 120 may be determined in an alternative manner. In this scenario, the E-UTRAN eNB 120 may broadcast its location and the distance thresholds. The WTRU 110 can then estimate its transmission distance to the serving eNB 120 and compare against the broadcast distance threshold values to determine which type and format of RACH preamble to select.

It should be noted that the methods described above for selecting a RACH or RACH resource may be applied in combination with one another. For example, in a large cell, multiple RACHs may be configured with a normal cyclic prefix type preamble while one may be configured with an extended type. The WTRU 110 may select a normal cyclic prefix type RACH preamble by utilizing the method 300 of FIG. 3, and then select a particular RACH from the multiple normal burst type RACHs in accordance with equations (1) or (2).

A WTRU, such as WTRU 110, may also select and partition non-dedicated preambles. The current state of technology allows for the division of non-dedicated preamble into sub-groups that may be based upon an intended message size, (e.g., msg-3), radio condition, or no partitioning at all. Grouping and selection may therefore be employed by the WTRU 110.

In one example, non-dedicated preambles may be divided based upon a composite value of the message size and the radio condition. The message size may be the number of resource blocks (RBs) needed in one transmission time interval (TTI) given the WTRU's perceived radio condition. The radio condition of the WTRU 110 may be from the perceived general cell radio condition, (e.g., the experienced pathloss), that may reflect whether or not the WTRU 110 is close to the center of the cell, at the edge of the cell, or may reflect the radio propagation condition.

In general, the larger the pathloss, the more difficult it is for the WTRU 110 to transmit a message successfully, (e.g., the data is received with a satisfactory block error rate (BER)). Additionally, the larger the message size, the more difficult it may be to successfully transmit it.

Accordingly, the WTRU 110 may utilize a composite-RF-message-size in selecting and partitioning a non-dedicated RACH preamble group by comparing that factor against a threshold. This may be performed in accordance with the following equation:

UE-Composite-value-RF-MessageSize=(RF-factor×MessageSize-factor); and

Pathloss=E-UTRAN-TX-Power−UE-measured-RSRP, Equation (5)

where the pathloss is the RF factor and the E-UTRAN may broadcast the TX-Power and threshold values.

An alternative way for dividing a non-dedicated preamble group for partitioning and group selection may be based on a service priority, call priority, or caller priority. The service priority, call priority, or urgency factor may be dependent upon the WTRU 110 upper layer service invocation. It may also be dependent upon the WTRU 110 upper layer call category, such as an emergency call, an urgency value such as when the WTRU 110 is out-of-service and needs to re-establish with the network.

The caller priority may refer to the privileged Access Class categories such as those defined for a public land mobile network (PLMN) operator, security operators and other network services. The E-UTRAN may also utilize the criteria described above to assign or distribute dedicated RACH access preambles to the WTRU 110.

Another way of partitioning and selecting non-dedicated preambles is to apply the knowledge that preambles generated with different cyclical shifts exhibit different performance in various WTRU 110 mobility situations, such as the speed of the WTRU 110. Accordingly, an LTE cell may be configured with two different groups of RACH preambles generated with different cyclical shifts such that one group is designated for normal mobility speed or normal radio propagation condition WTRUs 110 and the other group is designated for higher mobility speed or less optimal radio propagation condition WTRUs 110.

The E-UTRAN, or the eNB 120 cell, may configure the threshold for the WTRU 110 to select from one of the two WTRU mobility speed sensitive or radio propagation condition sensitive preamble groups. The WTRU 110 may utilize conventional speed detecting methods, such as the cell-selection or handover rate, WTRU positioning methods, or a GPS device, to determine its mobility speed. The WTRU 110 may then choose the appropriate preamble group by comparing the speed of the WTRU 110 to the speed threshold values.

The E-UTRAN may also utilize speed mobility of WTRUs 110 to assign and/or distribute dedicated RACH access preambles. In addition, it should be noted that any of the methods described above for selecting or partitioning preambles may be utilized in any combination with one another.

In another alternative method for selecting a non-dedicated preamble, it may be considered that there are N preambles within a preamble group for non-dedicated random access. The WTRU 110 may therefore select a non-dedicated preamble in accordance with the following equation:

Preamble-index=[RAND_{IMSI}×Current-SFN] mod N, Equation (6)

where RAND_{IMSI}×Current-SFN is a random number generated using a normalized product of the IMSI time of the WTRU 110 with the current-SFN as the seed. Accordingly, both the WTRU 110 privacy and the varying time, (e.g., with 10 ms granularity), are used as initial inputs to generate the random number. This may minimize the signature collision probability from various requesting WTRUs 110 on the same RACH preamble.

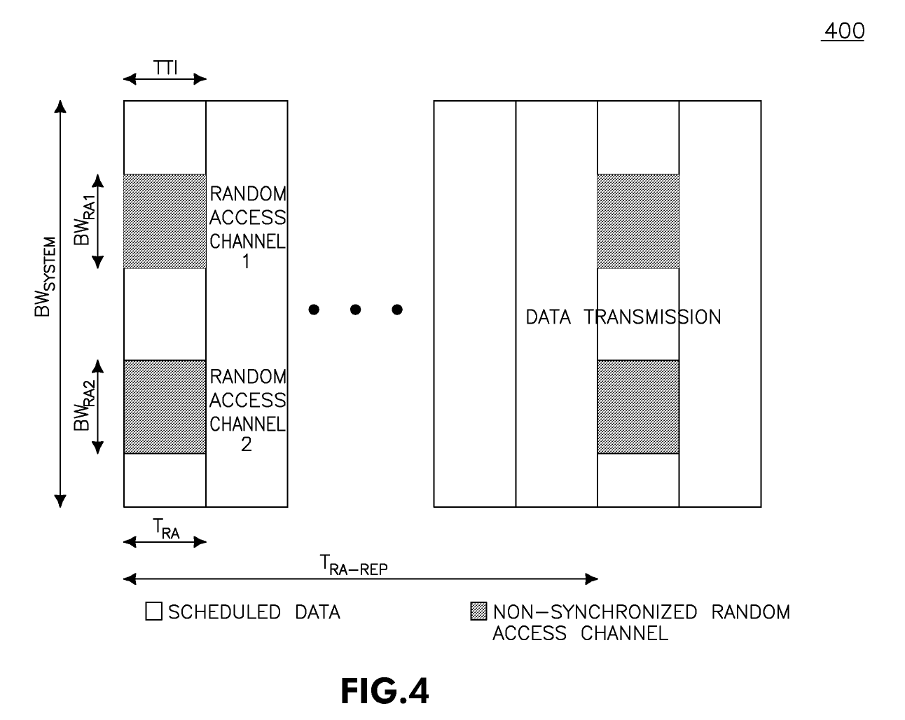

In the time domain, the WTRU 110 selection of a RACH preamble from the RACH channels of a same burst type may include a number of different scenarios. For example, a single or multiple RACH may be utilized where the bursts from different channels are time aligned. FIG. 4 is an example diagram 400 of time aligned RACH preambles on different channels.

In a single channel scenario, a WTRU 110 desiring to access the RACH, (e.g., a non backoff case), may make use of the first immediate available burst unless another possible RACH access restriction exists, such as the UMTS persistence level evaluation, to overwrite it. In a multiple RACH channel scenario, the WTRU 110 may select a RACH among the available RACHs based on a RACH channel load factor or quality information, (e.g., UL interference), which may be published by the E-UTRAN via a system broadcast.

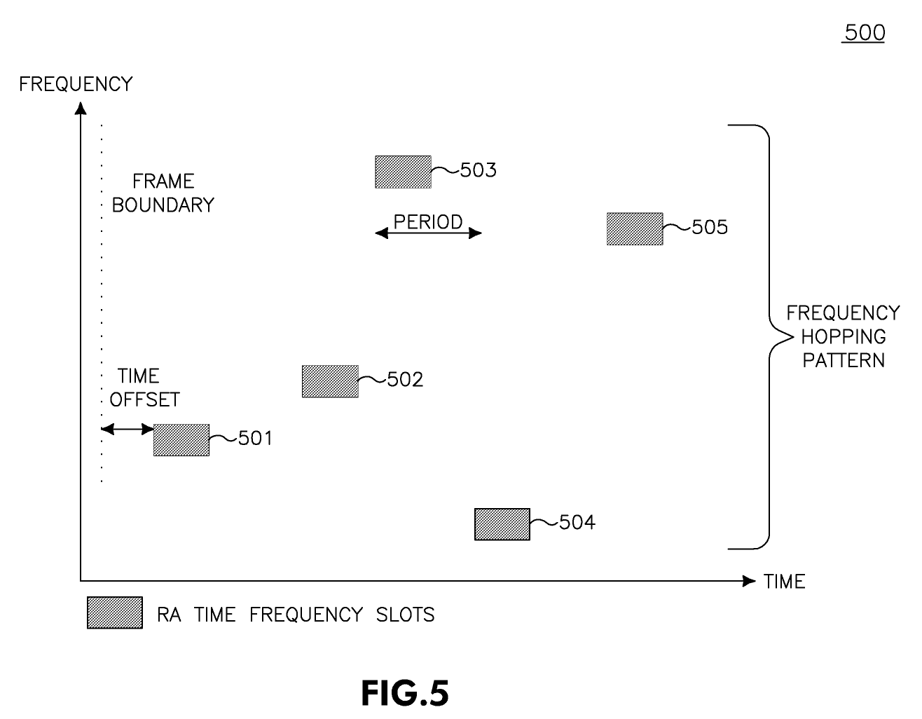

Alternatively, multiple RACH channels of the same preamble group or preamble format may have different random access preamble arrangements time-wise. That is, the random access (RA) preambles from multiple RACHs are spread time-wise. FIG. 5 is an example diagram 500 of time-wise spread RA preambles, (designated 501, 502, 503, 504, and 505). A WTRU 110 may select a time domain preamble across several available RACHs based upon which is the most immediate one. For example, as shown in FIG. 5, the WTRU 110 may select RA preamble 501 if the RACH access is requested at time zero (0) and if no other restrictions apply.

As an alternative to selecting a time domain preamble across several available RACHs based upon which is the most immediate one, the WTRU 110 could consider the RACH load factor for the RACH if it is within a period, (e.g., a RACH-access-delay-period). In this scenario, the WTRU 110 may select a preamble from a RACH channel having the lightest load. For example, continuing to refer to FIG. 5, if an allowed RACH-access-delay-period includes the three leftmost RA preambles, (i.e., RA preambles 501, 502, and 503), then the RA preamble 502 may be selected as being in the RACH channel having the lightest load among the three.

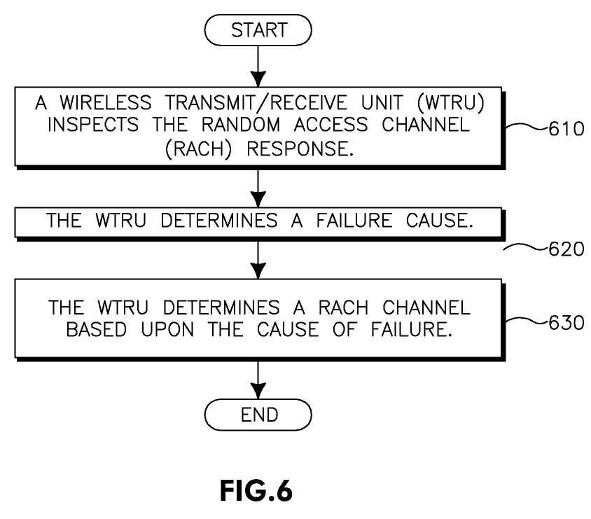

In all of the cases described above, RACH access by the WTRU 110 may not always be successful, and the WTRU 110 may desire to determine a cause of failure and possible subsequent RACH selection handling procedures. FIG. 6 is flow diagram of a method 600 of determining a failure cause.

In step 610, the WTRU 110 inspects the RACH response in order to determine the failure cause (step 620). For example, if the signature index that the WTRU 110 has chosen for a random access request is matched by the random access response but the random id in the request is not, then the failure cause can be determined as being due to propagation loss. If the signature index cannot be determined from the RACH response, then the failure cause may be considered to be from a collision. In this latter case, a RACH access backoff may be needed for another RACH access attempt. A RACH access backoff occurs when a random access collision is detected, and the WTRUs involved the collision retry the access again, but each chooses a different time delay in order not to collide again.

Once the cause of failure is determined in step 620, the WTRU 110 may determine a RACH channel based upon the cause of failure (step 630). The failure cause may also be used to determine preamble group selection and preamble selection for a subsequent RACH access attempt, and may also influence the backoff algorithm used in the LTE network.

For example, if the failure cause is determined as being due to propagation loss, the WTRU 110 may select the RACH channel with the preamble cyclic prefix type for a longer preamble, and may select a preamble group that can be utilized in potentially harsh transmission conditions if such a preamble group or preamble exists and is configured.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for random access channel (RACH) channel selection in a long term evolution (LTE) network, implemented in a wireless transmit/receive unit (WTRU), comprising:
determining a distance from the WTRU to an evolved Node-B (eNB) in a cell of the LTE network; and
selecting a RACH channel based upon the distance determination.

2. The method of claim 2 wherein the RACH channel includes any one of the following cyclic prefix types: a normal type, an extended type, and a repeated type.

3. The method of claim 3, further comprising selecting a RACH channel having normal cyclic prefix type if the distance from the transmitter is a first distance, a RACH channel having an extended type if the distance from the transmitter is a second distance, and a RACH channel having a repeated type if the distance from the transmitter is a third distance.

4. The method of claim 3 wherein the first distance is less than the second and third distances.

5. The method of claim 4 wherein the second distance is less than the third distance.

6. The method of claim 1 wherein determining the distance from the WTRU to the eNB includes measuring a pathloss of power on a downlink (DL) channel over reference symbols.

7. The method of claim 1, further comprising receiving a transmit power indication of a downlink (DL) channel.

8. The method of claim 1 wherein determining the distance from the WTRU to the eNB includes receiving information from a global positioning system (GPS) device.

9. The method of claim 1, further comprising selecting a non-dedicated preamble of a RACH.

10. The method of claim 9 wherein the non-dedicated preamble is selected based upon a radio condition of a cell and a message size for transmission.

11. The method of claim 9 wherein the non-dedicated preamble is selected based upon a service or call priority.

12. The method of claim 9 wherein the non-dedicated preamble is selected based upon a mobility speed.

13. The method of claim 12 wherein a first group of preambles is designated for a first mobility speed and a second group of preambles is designated for a second mobility speed.

14. A method implemented in a wireless transmit/receive unit (WTRU) for determining a failure cause for an unsuccessful random access channel (RACH) access, comprising:
inspecting a RACH response received by the WTRU;
determining a failure cause; and
selecting a RACH based upon the failure cause.

15. The method of claim 14 wherein detecting the failure cause includes comparing a chosen signature index and random ID to a signature index and random ID in the RACH response.

16. The method of claim 15 wherein, if the chosen signature index matches the signature index in the RACH response and the chosen random ID does not match the random ID in the RACH response, further comprising selecting a RACH channel having a longer preamble type.

17. The method of claim 14, further comprising failing to detect a signature index in the RACH response.

18. The method of claim 17, further comprising performing a RACH access backoff.

19. A wireless transmit/receive unit (WTRU), comprising:
a receiver;
a transmitter; and
a processor in communication with the receiver and the transmitter, the processor configured to determine a distance from an evolved Node-B (eNB) in a cell of a long term evolution (LTE) network, and select a random access channel (RACH) channel based upon the distance determination.

20. The WTRU of claim 19 wherein the processor is further configured to select a RACH channel having a normal cyclic prefix type if the distance from the transmitter is a first distance.

21. The WTRU of claim 20 wherein the processor is further configured to select a RACH channel having an extended cyclic prefix type if the distance from the transmitter is a second distance.

22. The WTRU of claim 20 wherein the processor is further configured to select a RACH channel having a repeated cyclic prefix type if the distance from the transmitter is a third distance.

23. The WTRU of claim 19 wherein the processor is further configured to measure the pathloss of power on a downlink (DL) channel over reference symbols.

24. The WTRU of claim 19 wherein the processor is further configured to select a non-dedicated preamble of a RACH based upon a radio condition of a cell and a message size for transmission.

25. A wireless transmit/receive unit (WTRU), comprising:
a receiver;
a transmitter; and
a processor in communication with the receiver and the transmitter, the processor configured to inspect a random access channel (RACH) response, determine a failure cause, and select a RACH based upon the failure cause.

26. The WTRU of claim 25 wherein the processor is further configured to compare a chosen signature index and random ID to a signature index and random ID in the RACH response.

27. The WTRU of claim 26 wherein the processor is further configured to select a RACH channel having longer preamble type if the chosen signature index matches the signature index in the RACH response and the chosen random ID does not match the random ID in the RACH response.

28. The WTRU of claim 25 wherein the processor is further configured to perform a RACH access backoff after failing to detect a signature index in the RACH response.
